(19) United States
(12) Patent Application Publication
(10) Pub. No.: US 2008/0187073 A1
(43) Pub. Date: Aug. 7, 2008

(54) Transmitter Apparatus

(75) Inventors: Alexander Lampe, Leipzig (DE); Rainer Dietsch, Baiensdorf (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/722,971

(22) PCT Filed: Dec. 21, 2005
(86) PCT No.: PCT/IB05/54370

§ 371 Date: Dec. 18, 2007

(30) Foreign Application Priority Data
Dec. 27, 2004 (EP) 04106997.2

(51) Int. Cl. H04L 27/36

(52) U.S. Cl. 375/298

(57) ABSTRACT

A transmitter apparatus (1) comprises a digital modulator (2), wherein the modulator is adapted to output a digital in-phase signal and a digital quadrature signal. The digital in-phase signal is converted to an analog in-phase signal and further processed in a path (31) for the in-phase signal, and a digital quadrature signal is converted in an analog quadrature signal and further processed in a path (34) for the quadrature signal. Thereby, an amplitude and delay mismatch in the path can occur. With the transmitter apparatus (1) of the invention the amplitude and delay mismatch can be measured. Further, an amplitude correction unit (43) is adapted for correcting the amplitude mismatch and a delay unit (3) is adapted to correct the delay mismatch. Further refinements of the amplitude and delay mismatch can be made with one or more predetermined test signals generated by a test signal generating unit (30).

The present invention relates to a transmitter apparatus, especially a baseband transmitter for a wireless communications system, and a method for measuring and compensating a signal imbalance. More particularly, the present invention relates to a transmitter apparatus adapted for compensation of amplitude and delay mismatches and a method for measurement and compensation of amplitude and delay mismatches for mobile communications systems like Global System for Mobile Communications (GSM) or Enhanced Data Rates for GSM Evolution (EDGE).

State of the art document U.S. 2002/0015450 A1 describes a method and an arrangement for determining correction parameters used for correcting phase and amplitude imbalance of an in-phase/quadrature modulator in a transmitter. Thereby, a coupler is arranged at an antenna to couple out after an amplifier the high frequency signal generated by the transmitter. This high frequency signal is sampled and the phase and amplitude imbalance caused by the in-phase/quadrature modulator is determined on the basis of the sampled signal. Hence, the method and arrangement known from U.S. 2002/0015450 A1 discloses a method and arrangement for determining the correction parameters of phase and amplitude on the basis of the determined phase and amplitude imbalance.

The method and arrangement known from U.S. 2002/0015450 A1 have the disadvantage that the phase imbalance is corrected with respect to a single test frequency. A further disadvantage is the outcoupling of the test signal after the power amplifier so that the measurement is impaired due to noise from the power amplifier.

It is an object of the invention to provide a transmitter apparatus for correcting a delay and amplitude imbalance and a method for measuring and compensating such a delay and amplitude imbalance of a transmitter apparatus.

This object is solved by a transmitter apparatus as defined in claim 1 and by a method as defined in claim 12. Advantageous developments of the invention are mentioned in the dependent claims.

The present invention has the advantage that instead of a phase imbalance a delay imbalance of at least a part of the transmitter apparatus can be measured and can be corrected with said delay unit. This delay imbalance can be measured in the baseband before a power amplifier so that this measurement and correction is not influenced by the noise of the power amplifier or other devices of the high frequency part of the transmitter.

The measure as defined in claim 2 has the advantage that at least one of the signal paths, the in-phase path or the quadrature path, is delayed on the side of the digital path of the transmitter so that independent of the frequency a certain delay can be applied. Hence, a resultant phase shift of the analog in-phase signal or the analog quadrature signal is frequency dependent due to the fixed delay.

The measure as defined in claim 3 has the advantage that the imbalance introduced by the analog part of the transmitter is compensated according to the determination of the determination unit. Thereby, the digital modulator, the digital to analog converters and the determination unit may be part of a single processor so that a processor individual setting can be achieved easily. Thereby, according to the measure as defined in claim 4, each of the delay elements can be built up by a latch.

The measures as defined in claims 5 and 6 have the advantage that the setting of the delay values can be optimized with respect to the master clock signal frequency and the in-phase/quadrature modulator output signal clock frequency, respectively. The granularity of delays which can be introduced in this way, and thereby the remaining overall path delay mismatch after compensation, is adjustable by the choice of the master clock frequency. In fact, the higher the frequency the finer is the granularity.

The measure as defined in claim 7 has the advantage, that both the analog in-phase signal and the analog quadrature signal are sampled and converted with the same equipment, so that a possible error of the measurement procedure is minimized. Hence, a very accurate measurement of the delay values can be performed.

The measure as defined in claim 8 has the advantage that both a delay and an amplitude imbalance can be measured and compensated.

The measures as defined in claims 9 and 10 have the advantage that an optimized and precise measurement can be performed. Thereby, it is advantageous that a fundamental frequency according to the coding scheme of the digital modulator is selected. Therewith, a periodic test signal matching the characteristic of the transmitter is generated. The measure as defined in claim 11 has the advantage that a average delay is provided with respect to a frequency dependent delay. An average estimation for an amplitude matching factor can be determined accordingly.

These and other aspects of the invention will be apparent from and elucidated with reference to the embodiment described hereinafter.

The present invention will become readily understood from the following description of preferred embodiments thereof made with reference to the accompanying drawings, in which like parts are designated by like reference signs and in which:

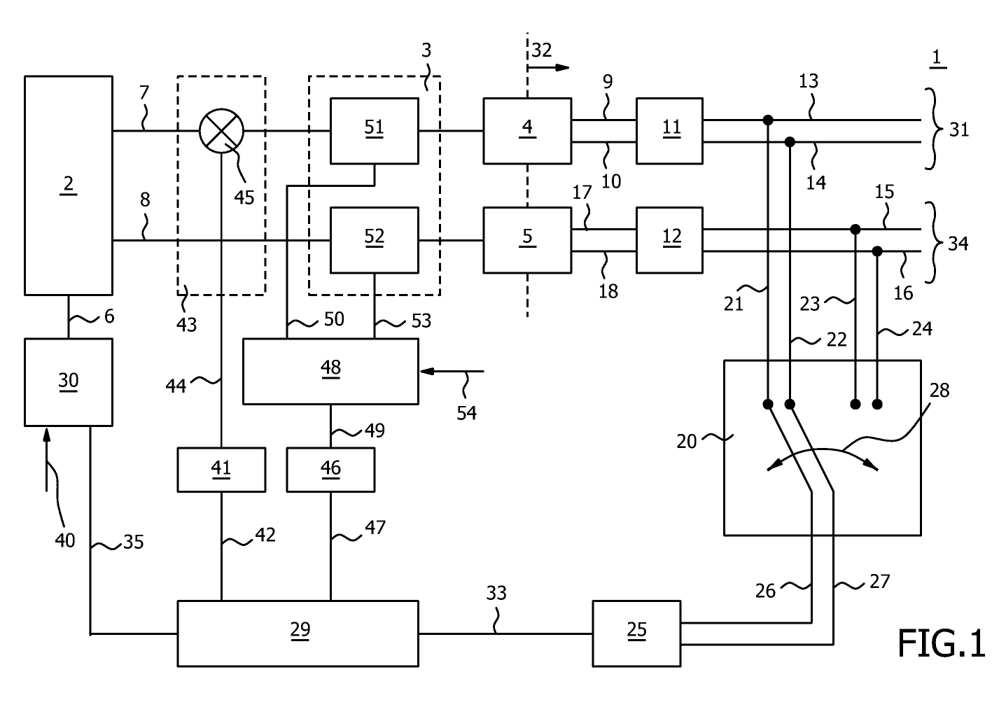

FIG. 1 shows a transmitter apparatus according to a preferred embodiment of the present invention; and

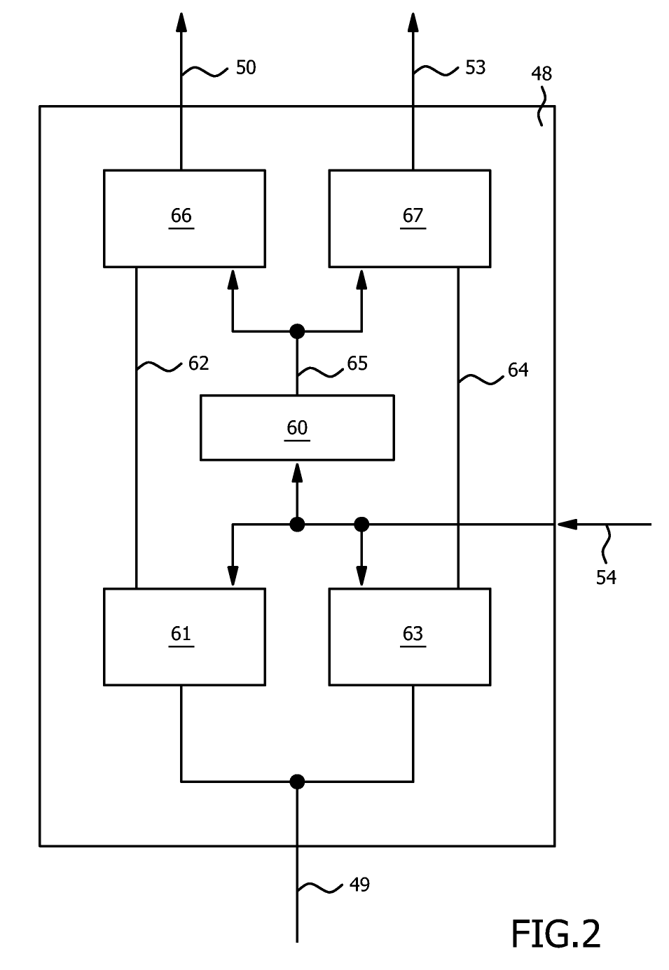

FIG. 2 shows a determination unit of the transmitter apparatus according to the preferred embodiment of the present invention in further detail.

FIG. 1 shows a schematic structure of a transmitter apparatus 1 according to the preferred embodiment of the invention. The transmitter apparatus 1 can be used for wireless communications systems like Global System for Mobile Communications (GSM) or Enhanced Data Rates for GSM Evolution (EDGE). The transmitter apparatus 1 and the method described below are applicable for transmitters 1 with a digital modulator 2 performing a digital in-phase/quadrature modulation.

The transmitter apparatus 1 comprises the modulator 2, a delay unit 3, a first digital to analog converter 4 and a second digital to analog converter 5. The modulator 2 is adapted to receive a digital signal over a line 6 and to convert the signal received in a digital in-phase signal and a digital quadrature signal. The digital in-phase signal is output from the modulator 2 over a line 7 to the converter 4. The digital quadrature signal is output over a line 8 to the converter 5. The converter 4 is adapted to convert the digital in-phase signal in a first analog in-phase signal and a second analog in-phase signal, which first and second analog in-phase signals are output over lines 9, 10 to low pass filters 11. Thereby, the two coupled low pass filters 11 are used for filtering the analog in-phase signals. The converter 5 is adapted to convert the digital quadrature signal into a first analog quadrature signal and a second analog quadrature signal, which first and second analog quadrature signals are output over lines 17 and 18 to low pass filters 12. Thereby, the two coupled low pass filters 12 are used for filtering the analog in-phase signals. It is advantageous to convert the digital in-phase signal and the digital quadrature signal in first and second analog signals, respectively, to take care of a common mode voltage. Thereby, it is advantageous that a half of the difference between the first and the second signal yields the value of the analog signal. But, it is also possible that the converter 4 outputs only a signal over a single line and that the converter 5 is adapted to output only a signal over a single line. The low pass filters 11, 12 are adapted to remove signal replicas at multiples of the digital sampling frequency so that the desired analog differential signals are output over lines 13 to 16. These signals output over lines 13 to 16 are baseband signals.

When generating the baseband signals in the transmitter apparatus 1 several impairments may occur and can lead to distortions of the signals. In particular, mismatches between the amplitudes and the delays of the in-phase and quadrature components of the signal result in an image of the signal. This problem may arise due to variations of analog components like the low pass filters 11, 12 required after the digital to analog converters 4, 5. In order to guarantee a certain signal quality the above mentioned impairments must not exceed certain limits. The image rejection, which is the ratio of the signal power to the power of its image and is therefore a function of the phase and amplitude mismatch, is used as a common parameter to measure the signal quality. For GSM or EDGE baseband transmitters 1 the lower limit for the image rejection, which is commonly around 40 dB at a frequency of 67 kHz, can be derived among others from the limits for the Gaussian minimum shift keying (GMSK) phase errors, EDGE error vector magnitude and signal amplitude ripple.

The transmitter apparatus 1 comprises a multiplexer 20. The multiplexer 20 is connected with lines 21, 22 to the lines 13, 14 to receive the in-phase signal consisting of the first in-phase signal and the second in-phase signal. The multiplexer 20 is connected via lines 23, 24 with the lines 15, 16 to receive the quadrature signal consisting of the first quadrature signal and the second quadrature signal. The multiplexer 20 is adapted to feed either the analog in-phase signal or the analog quadrature signal to an third analog to digital converter 25, wherein in one switching position the line 21 is connected over the multiplexer 20 with a line 26 and the line 22 is connected with a line 27, and in another switching position the line 23 is connected with the line 26 and the line 24 is connected with the line 27. The switching of the multiplexer 20 is shown by a double arrow 28. Hence, the multiplexer 20 feeds either the analog in-phase signal or the analog quadrature signal to the third converter 25.

The third analog to digital converter 25 is arranged to convert the analog in-phase signal to a digital in-phase measuring signal and to output this digital in-phase measuring signal to a calculation unit 29 over a line 33. Further, in the other switching position of the multiplexer 20, the third converter 25 converts the analog quadrature signal to a digital quadrature measuring signal and outputs this digital quadrature measuring signal to the calculation unit 29.

The transmitter apparatus 1 comprises a test signal generating unit 30 for generating a digital test signal. The test signal generated is fed to the digital modulator 2 over a line 6. At a first time instant a first test signal is generated and converted by the converters 4, 5 in an analog in-phase signal and an analog quadrature signal. The multiplexer 20 is in one of the switching positions 28 so that, for example, the analog in-phase signal is fed to the third converter 25. Hence, a first test signal is received and stored by the calculation unit 29, wherein the digital in-phase measuring signal depends on the characteristic features of an in-phase path 31, especially an analog part 32 of the in-phase path 31.

Then, at a second time instant a further test signal comprising the same bit stream as the foregoing test signal is generated by the test signal generating unit 30. Now, the multiplexer 20 is in the other switching position so that the quadrature signal derived from the further test signal is fed to the third converter 25 and received and stored as a digital quadrature measuring signal in the calculation unit 29. The form of the digital quadrature measuring signal is influenced by the quadrature path 34, especially by the analog part 32 of the quadrature path 34. The test signal generating unit 30 sends a trigger signal to the calculation unit 29 over a line 35 each time, when generating a test signal, so that the timing of the measuring signals can be compared by the calculation unit 29.

The calculation unit 29 calculates the delay mismatch and the amplitude mismatch in the in-phase and quadrature signals. Thereby, the third converter 25 can convert the analog differential signals into digital single-ended signals with the sampling clock frequency that is not necessarily equal to the clock frequency of the converters 4, 5. It is also possible that the third converter 25 delivers a differential digital signal.

In order to obtain at least a delay value and an amplitude matching factor the modulator 2 is fed with a test signal of a periodic input bit stream so that a periodic analog in-phase and quadrature signal is generated. If a GMSKIEDGE modulator 2 is used, periodic signals with fundamental frequencies having an absolute value of 13/768 MHz, 39/768 MHz, 13/192 MHz, 65/768 MHz, etc. can be created. As described above, at least two test signals comprising such a pre-defined bit stream are supplied to the digital modulator 2. First, the analog in-phase signal is passed to the third converter 25 and sampled with a sampling clock being synchronized to the modulator clock yielding the samples SI(k). Second, the analog quadrature signal is passed to the converter 25 and is sampled at the time instance defined by the trigger signal received over the line 35 yielding the samples SQ(k). Thereby, k is a positive integer counting the samples. When the sampling frequency of the third converter 25 is set as a multiple of the fundamental frequencies of the periodic test signals, for example, as 13/24 MHz if for example the absolute values of the test signals' frequencies are 13/192 MHz or 13/768 MHz, the in-phase signal samples SI(k) and the quadrature signal samples SQ(k) are shifted versions of each other. Assuming for example that the shift equals N samples, then the following equations are at least approximately fulfilled if the signals are passed through an appropriately chosen lowpass filter to remove higher harmonics if necessary:

SI(k)=2AGm cos(2πF k+2πfτi+2 πf τm)+ni(k),

SQ(k)=2GAGm cos(2 πF(k−N)+2 πfτi+ΔΦ+2πf τm)+nq(k).

Thereby, A is the nominal value of the amplitude, Gm and τm designate the gain and delay of the measurement path, respectively; F is defined as the ratio of the signal frequency and the digital sampling clock frequency of the third converter 25; f is the periodic test signal frequency; and, because the measurement is focused on the relative delay difference τq−τi=ΔpΦ/(2πf) between the delay τi of the in-phase path 31 and the delay τq of the quadrature path 34, the delay of the in-phase path τi can be chosen as zero without limiting the present invention. Further, ni(k) and nq(k) designate the noise interfering the measurement of the in-phase and quadrature signal, respectively.

From these equations, the amplitude matching factor G which is defined as the ratio of the effective amplitude for the quadrature part of the signal and the effective amplitude of the in-phase part of the signal, and the delay (time shift) between the measured test signals can be derived, when the samples SI(k) and SQ(k) are compared by means of the calculation unit 29.

In case that the noise interfering the samples SI(k) and SQ(k) is white Gaussian noise, a maximum likelihood estimate for the delay and amplitude of the in-phase signal can be calculated to derive ΔΦ=2πf τm and Am=2 A Gm. The maximum likelihood estimation for and Δφ is solved as the solution to the optimization problem:

(Δφ, Am)=argmin for Δφ and Am of the sum from k=1 up to the number of samples M over (SI(k)−Am cos(2πF k+Δφ))̂2.

With this estimates for Δφ and Am, the maximum likelihood estimates for ΔΦ and G are obtained from the calculation unit 29 by solving the optimization problem:

(ΔΦ, G)=argmin for ΔΦ and G of the sum from k=1 up to M over (SQ(k)−G Am sin(2πF k+Δφ+ΔΦ))̂2.

Hence, an estimate for an amplitude matching factor G is obtained. Further, the maximum likelihood estimate for the path delay is obtained as a fraction value consisting of a numerator that is the estimate for ΔΦ and an denominator that is the product of 2, π and the frequency f.

When SI(k−N) approximately equals SQ(k) for all k greater or equal N and less or equal M, the amplitude matching factor G (average amplitude ratio) can be calculated by the calculation unit 29 with an alternative calculation. In this case, the amplitude matching factor G can be obtained as a fraction value consisting of a numerator which is the sum over all SI(k−N) and a denominator which is the sum over all SQ(k), wherein in both sums the index k is an integer within the range from N to M for which the absolute value of SI(k) and the absolute value of SQ(k) is not less than a threshold that has to be chosen such that merely samples with sufficiently large magnitudes are summed up so that the delay mismatch ΔΦ does not affect the amplitude mismatch estimate.

The delay between the in-phase path 31 and the quadrature path 34 can be found as follows. First, the samples SI(k) and SQ(k) are sliced and filtered with a low pass having a cutoff frequency that is not less than the frequency of the periodic test signal, but also not greater than two times this frequency. This yields for the in-phase signal at the low pass filter output after appropriate normalization:

LI(k)=cos(2πFk+2πfτm)

and for the quadrature signal:

LQ(k)=sin(2πFk+ΔΦ+2πfτm).

Thereby, LI(k) are the samples of the low pass filter output for the in-phase signal and LQ(k) are the samples for the quadrature signal. The calculation unit 29 calculates the mean of the products of LI(k) and LQ(k) over m samples out of the M samples so that the estimate for the delay of the quadrature path 34 relative to the in-phase path 31 can be calculated as a fraction value consisting of a numerator that is the sum of the product of LI(k) and LQ(k) and a denominator that is the product of m, π and f, wherein the sum is counted over all integers k that are greater than an appropriately chosen offset accounting, for example, for the group delay of the low pass filter, up to the sum of m and this offset.

The test signal generating unit 30 is arranged to generate test signals with different frequencies, especially different fundamental frequencies. Therefore, the test signal generating unit 30 comprises an input 40 to select the frequency of the test signal generated. Hence, the delay and amplitude mismatch can be measured and calculated for various frequencies. On the basis of the calculated delay and amplitude mismatch a delay value and an amplitude matching factor can be derived as a weighted geometric average of the maximum likelihood estimates obtained independently for the different frequencies, wherein the weights can be chosen either as all ones or, for example, according to the average signal power transmitted at their respective signal frequency. The power of the geometric average can be chosen according to a desired norm, for example, as one or two. It is also possible, that the delay and amplitude mismatch can be derived as joint maximum likelihood estimates by extending the above mentioned optimizations such that it is conducted for the various frequencies together.

Further, a test signal with vanishing frequency, that is a direct current signal, can be generated with equal amplitude on the in-phase path 31 and quadrature path 34. Therewith, the maximum likelihood estimate for the amplitude mismatch can easily be calculated by the calculation unit 29.

The transmitter apparatus 1 comprises a memory 41 for storing a quantized amplitude matching factor G calculated by the calculation unit 29. This amplitude matching factor is input to the memory 41 over a line 42 from the calculation unit 29. The amplitude matching factor G is output to an amplitude correction unit 43 over a line 44. The amplitude correction unit 43 comprises a mixer 45 which is arranged to multiply the digital in-phase signal output from the modulator 2 with the amplitude matching factor G in order to compensate for the amplitude mismatch of the transmitter apparatus 1. It is also possible, that the amplitude correction unit 43 comprises a mixer (not shown) for multiplying the digital quadrature signal output from the modulator 2 over line 8 with the reciprocal value of the amplitude matching factor. Further, the amplitude correction unit 43 can also comprise two mixers 45, to multiply both the in-phase signal output from the modulator 2 over line 7 and the quadrature signal output over line 8 with a first amplitude matching factor and a second amplitude matching factor, wherein the fraction value of the first amplitude matching factor and the second amplitude matching factor is the amplitude matching factor G calculated by the calculation unit 29.

The transmitter apparatus 1 comprises a further memory element 46 for storing a time shift value measured between the analog part 32 of the path 31 for the analog in-phase signal and the analog part 32 of the path 34 for the analog quadrature signal. The time shift value input to the memory element 46 over a line 47 from the calculation unit 29, can be positive, negative, or zero.

The time shift value is input to a determination unit 48 from the memory element 46 over a line 49. The determination unit 48 is adapted to output a first delay value over a line 50 to a first delay element 51 of the delay unit 3, and is arranged to output a second delay value to a second delay element 52 over a line 53. The first delay element 51 is arranged between the digital modulator 2 and the first converter 4 and is adapted to delay the digital in-phase signal output from the modulator 2 with a delay defined by the first delay value. Accordingly, the second delay element 52 is arranged between said digital modulator 2 and the second converter 5 and is adapted to delay the digital quadrature signal output from the modulator 2 over the line 8 with a delay defined by the second delay value. Thereby, each of the first and second delay values is greater or equal to zero.

A master clock signal with a frequency that is, in general, a multiple of the digital modulator 2 output signal clock frequency, for example 12 times 52/12 MHz=52 MHz, is fed to the determination unit 48 over the input line 54. The determination unit 48 is described in further detail with reference to FIG. 2.

FIG. 2 shows the determination unit 48 of the transmitter apparatus 1. The determination unit 48 comprises a counter 60 for counting the master clock frequency modulo a value defined by the fraction value of the master clock signal frequency and the digital modulator 2 output signal clock frequency. For example, when the digital modulator 2 output signal clock frequency is 52/12 MHz and the master clock signal frequency is 12 times 52/12 MHz, i.e., 52 MHz, then the counter 60 counts modulo 12.

The determination unit 48 comprises a first calculation element for calculating the fraction value consisting of a numerator which is the product of −1 and the time shift value stored in the memory element 46 and a denominator that is the reciprocal of the frequency of the master clock signal input from line 54. Then, the first calculation element 61 outputs this fraction value, when this fraction value is greater than zero, and outputs a zero value otherwise over a line 62. A second calculation element 63 calculates a fraction value consisting of a numerator that is the time shift value stored in the memory element 46 and a denominator that is the reciprocal of the frequency of the master clock signal input over the input line 54. Then, the second calculation element 63 outputs this fraction value, when this fraction value is greater than zero, and outputs otherwise a zero value over a line 64. The output signal of the counter 60 is applied to a first comparator 66 and a second comparator 67 over a line 65. The first comparator 66 compares the counter signal value from the counter 60 with the output value from the first calculation element 61. If the output signal of the counter 60 is greater or equal to the output from the first calculation element 61, then a delay is set for the first delay element 51, and no delay is set for the first delay element 51 otherwise. When the output signal from the counter 60 is greater or equal than the output of the second calculation element 63, then the second comparator 67 sets a delay value for the second delay element 52, and sets no delay otherwise.

Therewith, it is attained that for positive delays (time shift values), when the quadrature signal advances relative to the in-phase signal without compensation, the bits of the digital in-phase signal are released for a zero value output of the counter 60, and the bits of the digital quadrature signal are released for a counter 60 output that equals the greatest integer that is less than or equal to the fraction value consisting of a numerator that is the time shift value and a denominator that is the reciprocal of the master clock signal frequency so that a delay of an amount that is the product of this fraction value and the reciprocal of the master clock signal frequency is added to the quadrature signal relative to the in-phase signal. And, for negative delays, when the in-phase signal advances relative to the quadrature signal without compensation, the bits of the digital quadrature signal are released for an output signal of the counter 60 equal to zero and the bits of the digital in-phase signal are released for a counter signal that equals the greatest integer that is less than or equal to the fraction value consisting of a numerator that is the product of −1 and the time shift value and a denominator that is the reciprocal of the master clock signal frequency so that a delay of an amount of this fraction value and the reciprocal of the master clock signal frequency is added to the in-phase signal relative to the quadrature signal.

The granularity of delays which can be introduced according to the preferred embodiment, and thereby the remaining overall path delay mismatch after compensation, is adjustable by the choice of the master clock frequency.

Only for the way of illustration and not limiting the present invention, an example for an attainable performance after compensation is described below. When the master clock signal frequency is set to 52 MHz, the granularity of the delay compensation equals 19.2 ns. Supposing an amplitude swing of 2 Vpp on the analog differential signals while using 10-bit digital to analog converters, one least significant bit in the digital part of the transmit path represents 2 mVpp. Hence, the maximum amplitude difference between the in-phase path 31 and the quadrature path 34 after compensation equals about 8 mVpp/2=4 mVpp, when assuming a multiplier with an effective resolution of 8 bit. This corresponds to a maximum amplitude mismatch after compensation of 1.002.

With these values and calculating the minimum attainable image rejection for the modulator 2 frequency of 67 kHz, the image rejection after compensation is by far better than 50 dB.

Although an exemplary embodiment of the invention has been disclosed, it will be apparent to those skilled in the art that various changes and modifications can be made which will achieve some of the advantages of the invention without departing from the spirit and scope of the invention, such modifications to the inventive concept are intended to be covered by the appended claims in which the reference signs shall not be construed as limiting the scope of the invention. Further, in the description and the appended claims the meaning of “comprising” is not to be understood as excluding other elements or steps. Further, “a” or “an” does not exclude a plurality, and a single processor or other unit may fulfill the functions of several means recited in the claims.

1. Transmitter apparatus, especially baseband transmitter for a wireless communications system, which transmitter apparatus comprises a digital modulator, a delay, a first digital to analog converter and at least a second digital to analog converter, wherein said modulator is adapted to receive at least a digital signal and to output at least a digital in-phase signal and at least a digital quadrature signal, said first converter is adapted to convert said digital in-phase signal output from said modulator to at least an analog in-phase signal, said second converter is adapted to convert said digital quadrature signal output from said modulator to at least an analog quadrature signal, and said delay unit is adapted to add a time shift to said digital quadrature signal relative to said digital in-phase signal.

2. Transmitter apparatus according to claim 1, characterized in that said delay unit comprises a first delay element arranged between said modulator and said first converter and at least a second delay element arranged between said modulator and said second converter, wherein said first delay element is adapted to delay said digital in-phase signal output from said modulator, and said second delay element is adapted to delay said digital quadrature signal output from said modulator.

3. Transmitter apparatus according to claim 2, characterized by a determination unit to determine a first delay value set for said first delay element and at least a second delay value set for said second delay element on the basis of a time shift value measured between an analog part of a path for said analog in-phase signal and an analog part of a path for said analog quadrature signal.

4. Transmitter apparatus according to claim 3, characterized in that said delay value is not less than zero and said second delay value is not less than zero.

5. Transmitter apparatus according to claim 3, characterized in that said determination unit determines said first delay value and said second delay value also on the basis of a frequency of a master clock signal.

6. Transmitter apparatus according to claim 5, characterized in that said frequency of said master clock signal is an integral multiple of an output signal clock frequency of said modulator.

7. Transmitter apparatus according to claim 3, characterized by a multiplexer for feeding either said analog in-phase signal or said analog quadrature signal to a third analog to digital converter, wherein said third converter is arranged to convert said analog in-phase signal to a digital in-phase measuring signal and to output said digital in-phase measuring signal to a calculation unit, and is arranged to convert said analog quadrature signal to a digital quadrature measuring signal and to output said digital quadrature measuring signal to said calculation unit, and said calculation unit calculates a delay between said digital in-phase measuring signal and said digital quadrature measuring signal.

8. Transmitter apparatus according to claim 7, characterized in that said calculation unit calculates an amplitude matching factor on the basis of an effective amplitude of said digital in-phase measuring signal and an effective amplitude of said digital quadrature measuring signal, and that an amplitude correction unit is adapting an amplitude of said digital in-phase signal output from said modulator and/or an amplitude of said digital quadrature signal output from said modulator on the basis of said amplitude matching factor.

9. Transmitter apparatus according to claim 3, characterized by a test signal generating unit for generating at least a digital test signal, wherein said test signal generating unit feeds said test signal to said digital modulator.

10. Transmitter apparatus according to claim 9, characterized in that said test signal generating unit generates a first digital test signal beginning at a first time instant with a specific bit stream, and generates at least a second digital test signal beginning at a second time instant with the same specific bit stream as for said first digital test signal.

11. Transmitter apparatus according to claim 9, characterized in that said test signal generating unit is adapted to generate at least two different kinds of test signals having different frequencies, and that said determination unit determinates said first delay value and said second delay value on the basis of an average estimation for a delay value on the basis of at least two time shift values, each of said time shift values measured between said analog part of a path for said analog in-phase signal and said analog part of a path for said analog quadrature signal with respect to one of said different frequencies.

12. Method for measuring and compensating a signal imbalance, especially an amplitude and/or delay imbalance, which method comprises:

13. feeding a first predetermined digital test signal to a digital in-phase and quadrature modulator of a transmitter apparatus;
converting an analog in-phase test signal output from said transmitter apparatus on the basis of said first digital test signal to a digital in-phase test signal;
feeding a second predetermined digital test signal to said modulator;
wherein said further predetermined digital test signal comprises the same bit stream as said first digital test signal;
converting an analog quadrature test signal output from said transmitter apparatus on the basis of said second digital test signal to a digital quadrature test signal;
measuring a time shift between said digital in-phase test signal and said digital quadrature signal; and
determining a delay value for correcting a time shift between an analog part of a path of said transmitter for an in-phase signal and a path of said transmitter for a quadrature signal on the basis of said time shift measured.
